(19) United States
(12) Patent Application Publication
(10) Pub. No.: US 2024/0261965 A1
(43) Pub. Date: Aug. 8, 2024

(54) METHOD AND APPARATUS FOR CALIBRATING CRANKSHAFT TO BE PROCESSED

(71) Applicant: ABB SCHWEIZ AG, Baden (CH)

(72) Inventors: Dianfei Xia, Shanghai (CN); Kun Chang, Shanghai (CN); Jiacheng Wang, Jinzhong, Shanxi (CN)

(21) Appl. No.: 18/639,696

(22) Filed: Apr. 18, 2024

Related U.S. Application Data
(63) Continuation of application No. PCT/CN2021/131452, filed on Nov. 18, 2021.

(51) Int. Cl. B25J 9/16; B25J 13/08; G01B 5/008

(52) U.S. Cl. CPC B25J 9/1653; B25J 13/089; G01B 5/008

(57) ABSTRACT

A method and an apparatus for calibrating a crankshaft to be processed. The method includes causing a positioner to rotate to at least three different angles. The positioner is configured to support the crankshaft and drive the crankshaft to rotate. The method also includes causing a probe to touch a plurality of points on a first cylindrical crankpin of the crankshaft respectively to obtain coordinates of the plurality of points in a robot coordinate system; fitting the coordinates of the plurality of points on the first cylindrical crankpin respectively to obtain a respective pose of the first cylindrical crankpin relative to the robot coordinate system; and determining a pose of a rotating axis of the crankshaft relative to the robot coordinate system based on the respective pose of the first cylindrical crankpin.

### FIELD

Embodiments of present disclosure generally relate to the field of crankshaft calibrating, and more particularly, to a method and an apparatus for calibrating a crankshaft to be processed.

### BACKGROUND

In the mechanical structure of a vehicle engine, a crankshaft is the most important part of the engine. The crankshaft is a mechanical equipment that transforms a reciprocating movement of a piston into a rotary motion. The crankshaft is connected to the piston through a connecting rod. During operation, the crankshaft will bear a force transmitted by the connecting rod and convert it into torque to drive other accessories on the engine to work.

The crankshaft is generally integrally formed from casts and is longitudinally divided into a plurality of parts, including a main journal, crankpins, crank arms, etc. These parts are irregularly distributed on the crankshaft such that the crankshaft has an asymmetric structure. Prior to the use, the crankshaft needs to be polished so as to reduce its friction force. When using a robot arm to polish a surface of the crankshaft, it is necessary to accurately know a spatial pose of the crankshaft in a robot coordinate system. Therefore, the spatial pose of the crankshaft to be polished needs to be calibrated before the polishing.

When calibrating the position of a regular workpiece with obvious geometric characteristics, the calibration can be carried out quickly and automatically, because there are good reference positions and reference points on the regular workpiece. For example, the calibration of the regular workpiece may be implemented through vision calibration. However, for irregular and asymmetric workpieces, such as the crankshaft, it is hard to achieve rapid and automated calibration and the accuracy of the calibration is difficult to be guaranteed, because there are not good reference positions and reference points on such workpieces.

Accordingly, there is a need for a new solution for calibrating the crankshaft to be polished quickly and accurately.

### SUMMARY

Example embodiments of the present disclosure provide solutions for calibrating a crankshaft to be processed, for example to be polished.

In a first aspect of the present disclosure, a method for calibrating a crankshaft to be processed is provided. The method comprises: causing a positioner to rotate to at least three different angles, wherein the positioner is configured to support the crankshaft and drive the crankshaft to rotate; causing, for each of the at least three different angles, a probe arranged on a robot to touch a plurality of points on a first cylindrical crankpin of the crankshaft respectively to obtain coordinates of the plurality of points in a robot coordinate system; fitting, for each of the at least three different angles, the coordinates of the plurality of points on the first cylindrical crankpin respectively to obtain a respective pose of the first cylindrical crankpin relative to the robot coordinate system; and determining a pose of a rotating axis of the crankshaft relative to the robot coordinate system based on the respective pose of the first cylindrical crankpin. With these embodiments, the pose of the rotating axis of the crankshaft can be calibrated quickly and accurately.

In some embodiments, the method further comprises: creating a first reference coordinate system based on the pose of the rotating axis such that the rotating axis coincides with one coordinate axis of the first reference coordinate system. With these embodiments, the first reference coordinate system is created so as to further calibrate other pose parameters of the crankshaft.

In some embodiments, the method further comprises: causing the positioner to rotate to a predetermined angle; determining a first angle of a central axis of a second cylindrical crankpin of the crankshaft in the first reference coordinate system when the positioner is at the predetermined angle; obtaining a second angle of the central axis of the second cylindrical crankpin in a second reference coordinate system of a simulation station when the positioner is at the predetermined angle; and determining an angular offset of the crankshaft based on a difference between the first angle and the second angle. With these embodiments, the angular offset of the crankshaft can be determined quickly and accurately.

In some embodiments, determining the first angle comprises: causing the probe to touch a plurality of points on the second cylindrical crankpin to obtain coordinates of the plurality of points on the second cylindrical crankpin in the robot coordinate system; fitting the coordinates of the plurality of points on the second cylindrical crankpin to obtain a pose of the second cylindrical crankpin relative to the robot coordinate system; and determining the first angle based on the pose of the second cylindrical crankpin and the first reference coordinate system. With these embodiments, the first angle can be determined accurately.

In some embodiments, the first cylindrical crankpin and the second cylindrical crankpin are the same one crankpin or different crankpins of the crankshaft.

In some embodiments, the method further comprises: causing the probe to touch an oil hole on a third cylindrical crankpin or a main journal of the crankshaft to obtain a first coordinate of the oil hole in the first reference coordinate system; obtaining a second coordinate of the oil hole in a second reference coordinate system of a simulation station; and determining a position offset of the crankshaft along the rotating axis based on the first coordinate and the second coordinate of the oil hole. With these embodiments, the position offset of the crankshaft along the rotating axis can be determined quickly and accurately.

In some embodiments, the first cylindrical crankpin and the third cylindrical crankpin are the same one crankpin or different crankpins of the crankshaft.

In a second aspect of the present disclosure, an apparatus for calibrating a crankshaft to be processed is provided. The apparatus comprises a probe arranged on a robot; a positioner configured to support the crankshaft and drive the crankshaft to rotate; and a controller configured to: cause the positioner to rotate to at least three different angles; cause, for each of the at least three different angles, the probe to touch a plurality of points on a first cylindrical crankpin of the crankshaft respectively to obtain coordinates of the plurality of points in a robot coordinate system; fit, for each of the at least three different angles, the coordinates of the plurality of points on the first cylindrical crankpin respectively to obtain a respective pose of the first cylindrical crankpin relative to the robot coordinate system; and determine a pose of a rotating axis of the crankshaft relative to the robot coordinate system based on the respective pose of the first cylindrical crankpin.

In some embodiments, the controller is further configured to: create a first reference coordinate system based on the pose of the rotating axis such that the rotating axis coincides with one coordinate axis of the first reference coordinate system.

In some embodiments, the controller is further configured to: cause the positioner to rotate to a predetermined angle; determine a first angle of a central axis of a second cylindrical crankpin of the crankshaft in the first reference coordinate system when the positioner is at the predetermined angle; obtain a second angle of the central axis of the second cylindrical crankpin in a second reference coordinate system of a simulation station when the positioner is at the predetermined angle; and determine an angular offset of the crankshaft based on a difference between the first angle and the second angle.

In some embodiments, the controller is configured to determine the first angle by: causing the probe to touch a plurality of points on the second cylindrical crankpin to obtain coordinates of the plurality of points on the second cylindrical crankpin in the robot coordinate system; fitting the coordinates of the plurality of points on the second cylindrical crankpin to obtain a pose of the second cylindrical crankpin relative to the robot coordinate system; and determining the first angle based on the pose of the second cylindrical crankpin and the first reference coordinate system.

In some embodiments, the first cylindrical crankpin and the second cylindrical crankpin are the same one crankpin or different crankpins of the crankshaft.

In some embodiments, the controller is further configured to: cause the probe to touch an oil hole on a third cylindrical crankpin or a main journal of the crankshaft to obtain a first coordinate of the oil hole in the first reference coordinate system; obtain a second coordinate of the oil hole in a second reference coordinate system of a simulation station; and determine a position offset of the crankshaft along the rotating axis based on the first coordinate and the second coordinate of the oil hole.

In some embodiments, the first cylindrical crankpin and the third cylindrical crankpin are the same one crankpin or different crankpins of the crankshaft.

In a third aspect, example embodiments of the present disclosure provide a computer readable medium having instructions stored thereon, the instructions, when executed on at least one processor, cause the at least one processor to perform the method according to the first aspect of the present disclosure.

According to embodiments of the present disclosure, the cylindrical crankpins are selected as the measurement target on the very complex and irregular crankshaft. Moreover, the crankshaft pose and central axis parameters can be calculated indirectly by measuring the movement difference of the target under multiple different attitudes.

According to embodiments of the present disclosure, analyzing and filtering the intermediate data and fitting the resulted data can provide a more accurate calibration result.

According to embodiments of the present disclosure, the calibration of the crankshaft can be carried out automatically, such that the measurement error of manual calibration is effectively avoided. In this way, the time consumed by the calibration can be saved, and the difficulty of calibration can be reduced. At the same time, the calibration process has a low cost and an extremely low error.

### DESCRIPTION OF DRAWINGS

Through the following detailed descriptions with reference to the accompanying drawings, the above and other objectives, features and advantages of the example embodiments disclosed herein will become more comprehensible. In the drawings, several example embodiments disclosed herein will be illustrated in an example and in a non-limiting manner, wherein:

FIG. 1 schematically illustrates an apparatus for calibrating a crankshaft to be processed according to an embodiment of the present disclosure;

FIG. 2 schematically illustrates example positions of a first cylindrical crankpin when a positioner rotates to three different angles according to an embodiment of the present disclosure;

FIG. 3 schematically illustrates an example process of sensing a plurality of points on the first cylindrical crankpin when the positioner is at one of the three different angles according to an embodiment of the present disclosure;

FIG. 4 schematically illustrates an example process of determining a pose of a rotating axis of the crankshaft relative to the robot coordinate system according to an embodiment of the present disclosure;

FIG. 5 schematically illustrates example positions of the first cylindrical crankpin when the positioner rotates to four different angles according to another embodiment of the present disclosure;

FIG. 6 schematically illustrates a first reference coordinate system created based on the pose of the rotating axis according to an embodiment of the present disclosure;

FIGS. 7A-7C schematically illustrate an example process of determining an angular offset of the crankshaft according to an embodiment of the present disclosure;

FIGS. 8A-8C schematically illustrate an example process of determining an angular offset of the crankshaft according to another embodiment of the present disclosure;

FIGS. 9A-9B schematically illustrate an example process of determining a position offset of the crankshaft along the rotating axis according to an embodiment of the present disclosure; and

FIG. 10 is a flowchart of a method for calibrating a crankshaft to be processed according to an embodiment of the present disclosure.

Throughout the drawings, the same or similar reference symbols are used to indicate the same or similar elements.

### DETAILED DESCRIPTION OF EMBODIMENTS

Principles of the present disclosure will now be described with reference to several example embodiments shown in the drawings. Though example embodiments of the present disclosure are illustrated in the drawings, it is to be understood that the embodiments are described only to facilitate those skilled in the art in better understanding and thereby achieving the present disclosure, rather than to limit the scope of the disclosure in any manner.

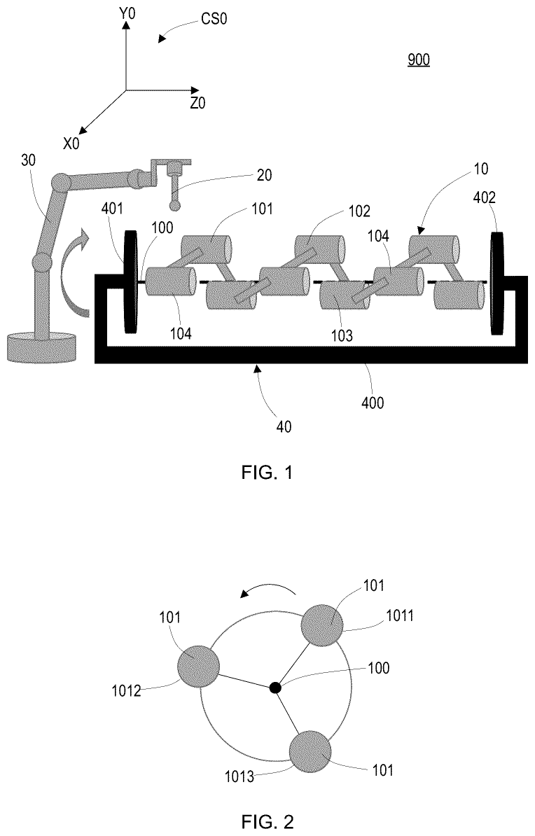

As described above, for the irregular and asymmetric crankshaft, it is hard to achieve rapid and automated calibration and the accuracy of the calibration is difficult to be guaranteed, because there are not good reference positions and reference points on the crankshaft. Example embodiments of the present disclosure provide solutions for calibrating the crankshaft. Hereinafter, principles of the present disclosure will be described in detail with reference to FIGS. 1-10.

FIG. 1 schematically illustrates an apparatus 900 for calibrating a crankshaft 10 to be processed according to an embodiment of the present disclosure.

As shown in FIG. 1, the crankshaft 10 includes a main journal 104 arranged around a rotating axis 100 of the crankshaft 10. The main journal 104 includes several parts spaced apart from each other. The crankshaft 10 further includes several cylindrical crankpins arranged eccentrically with respect to the rotating axis 100, such as a first cylindrical crankpin 101, a second cylindrical crankpin 102, a third cylindrical crankpin 103, etc. It is to be understood that the structure of the crankshaft 10 as shown in FIG. 1 is only an example, without suggesting any limitation to the scope of the present disclosure.

The apparatus 900 includes a probe 20, a positioner 40, and a controller (not shown). The probe 20 is arranged on a robot 30. For example, the probe 20 may be arranged on an end flange of the robot 30. The robot 30 may drive the probe 20 to move to various positions in a robot coordinate system CS0 including three coordinate axes X0, Y0, and Z0. The probe 20 may be used to touch an object so as to detect the position of the object in the robot coordinate system CS0. The probe 20 may be of any known type of any other type developed in the future. The positioner 40 is configured to support the crankshaft 10 and drive the crankshaft 10 to rotate. For example, the positioner 30 may support two ends of the crankshaft 10, such that a rotating axis of the positioner 401 coincides with the rotating axis 100 of the crankshaft 10. With such an arrangement, the positioner 40 may drive the crankshaft 10 to rotate to various angles.

In some embodiments, as shown in FIG. 1, the positioner 40 includes a base 400, a first positioning part 401 arranged on a side of the base 400, and a second positioning part 402 arranged on the other side of the base 400. The first positioning part 401 and the second positioning part 402 support the two ends of the crankshaft 10 respectively so as to drive the crankshaft 10 to rotate. It is to be understood that the structure of the positioner 40 as shown in FIG. 1 is only an example, without suggesting any limitation to the scope of the present disclosure.

In order to determine a pose of the rotating axis 100 of the crankshaft 10 relative to the robot coordinate system CS0, the controller may perform various control operations on the probe 20 and positioner 40.

As shown in FIG. 1, the controller may cause the positioner 40 to rotate to at least three different angles. When the positioner 40 is at the different angles, the crankpins on the crankshaft 10 will be located at different positons in the robot coordinate system CS0. In an embodiment, the controller may cause the positioner 40 to rotate to three different angles.

FIG. 2 schematically illustrates example positions of the first cylindrical crankpin 101 when the positioner 40 rotates to three different angles according to an embodiment of the present disclosure. As shown in FIG. 2, when the positioner 40 rotates to three different angles, the first cylindrical crankpin 101 is located at three different positions, i.e., a first position 1011, a second position 1012, and a third position 1013.

According to embodiments of the present disclosure, the positioner 40 may rotate to any three different angles in a range of 0-360 degree, such as 0 degree, 30 degree and 60 degree, or 10 degree, 50 degree and 100 degree, or other three different angles. The rotating angles of the positioner 40 may be selected according to the measurement accuracy or user requirements. The scope of the present disclosure is not intended to be limited in this respect.

When the first cylindrical crankpin 101 is at each of the first, second and third positions 1011, 1012, and 1013, the controller may then cause the probe 20 to touch a plurality of points on the first cylindrical crankpin 101 so as to determine the pose of the first cylindrical crankpin 101.

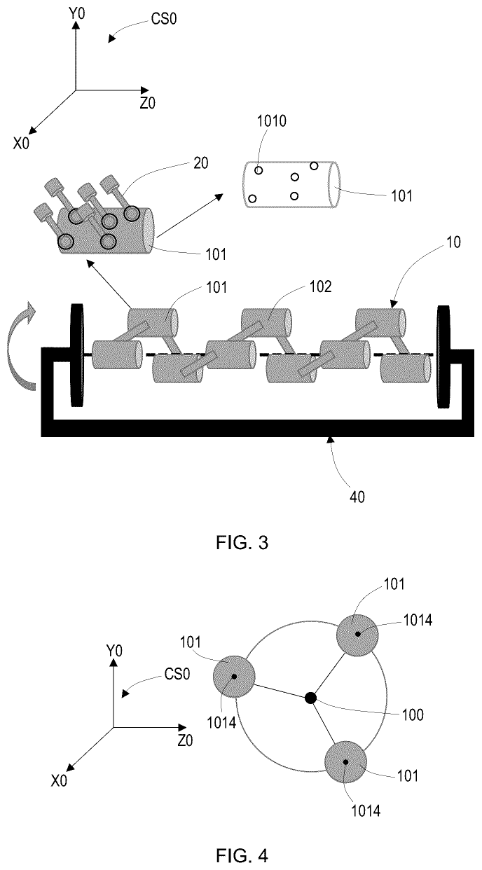

FIG. 3 schematically illustrates an example process of sensing a plurality of points 1010 on the first cylindrical crankpin 101 when the positioner 40 is at one of the three different angles. As shown in FIG. 3, when the positioner 40 is at one of the three different angles, the first cylindrical crankpin 101 is at one of the first, second and third positions 1011, 1012, and 1013.

Here, the first position 1011 will be used as an example to explain the example process of sensing the points on the first cylindrical crankpin 101. As shown in FIG. 3, when the positioner 40 is at a first one of the three different angles, the controller will cause the probe 20 to touch a plurality of points 1010 on the first cylindrical crankpin 101 to obtain coordinates of the plurality of points 1010 in the robot coordinate system CS0. Then, the controller may perform fitting on the coordinates of the plurality of points 1010 on the first cylindrical crankpin 101 to obtain the pose of the first cylindrical crankpin 101 relative to the robot coordinate system CS0. In some embodiments, the controller may use a known RANSAC fitting method to determine the pose of the first cylindrical crankpin 101. In other embodiments, the controller may use other fitting methods to determine the pose of the first cylindrical crankpin 101.

According to embodiments of the present disclosure, the number of the sensed points 1010 on the first cylindrical crankpin 101 may be predetermined according to the measurement accuracy or user requirements. For example, the probe 20 may touch several points, a dozen points, dozens of points or more points on the first cylindrical crankpin 101 when the positioner 40 is at each of the three angles. The scope of the present disclosure is not intended to be limited in this respect.

Likewise, when the positioner 40 is at a second one of the three different angles, the controller will also cause the probe 20 to touch a plurality of points on the first cylindrical crankpin 101 to obtain coordinates of the plurality of points in the robot coordinate system CS0. Then, the controller will perform analogous fitting on the coordinates of the plurality of points to determine the pose of the first cylindrical crankpin 101 at this time.

Furthermore, when the positioner 40 is at a third one of the three different angles, the controller will also cause the probe 20 to touch a plurality of points on the first cylindrical crankpin 101 to obtain coordinates of the plurality of points in the robot coordinate system CS0. Then, the controller will perform analogous fitting on the coordinates of the plurality of points to determine the pose of the first cylindrical crankpin 101 at this time.

With the above approaches, in the case that the positioner 40 is at each of the three different angles, the respective pose of the first cylindrical crankpin 101 relative to the robot coordinate system CS0 is determined. Then, the controller may determine a pose of the rotating axis 100 of the crankshaft 10 relative to the robot coordinate system CS0 based on the respective pose of the first cylindrical crankpin 101.

FIG. 4 schematically illustrates an example process of determining a pose of the rotating axis 100 of the crankshaft 10 relative to the robot coordinate system CS0 according to an embodiment of the present disclosure. As shown in FIG. 4, in the case that three poses of the first cylindrical crankpin 101 relative to the robot coordinate system CS0 have been determined, the respective pose of a central axis 1014 of the first cylindrical crankpin 101 is also known. Then, the controller may determine the pose of the rotating axis 100 of the crankshaft 10 relative to the robot coordinate system CS0 by using the respective pose of the central axis 1014 of the first cylindrical crankpin 101 based on the principle of three points determining a circle. As such, the pose of the rotating axis 100 of the crankshaft 10 relative to the robot coordinate system CS0 is obtained. With these embodiments, the pose of the rotating axis 100 of the crankshaft 10 can be calibrated quickly and accurately.

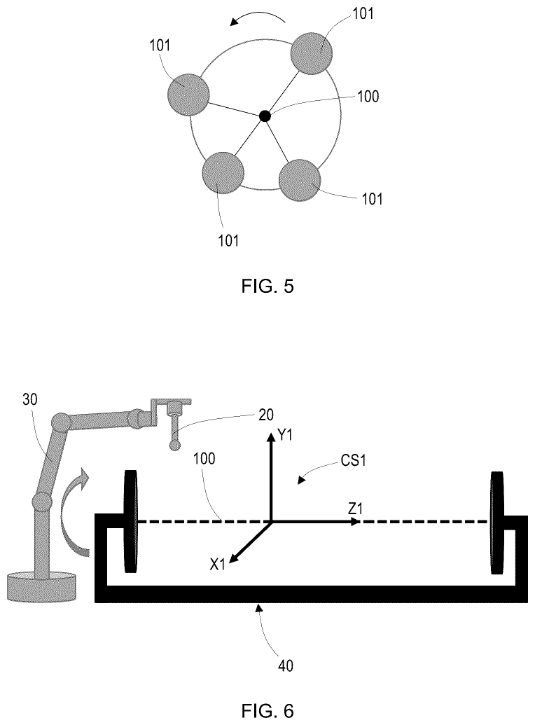

FIG. 5 schematically illustrates example positions of the first cylindrical crankpin 101 when the positioner 40 rotates to four different angles according to another embodiment of the present disclosure. As shown in FIG. 5, when the positioner 40 rotates to four different angles, the first cylindrical crankpin 101 will be located at four different positions. Similarly, the controller may cause the probe 20 to touch a plurality of points on the first cylindrical crankpin 101 respectively when the first cylindrical crankpin 101 is at each of the four different positions to obtain the coordinates of the plurality of points in the robot coordinate system CS0. Then, the controller may perform fitting on the coordinates of the plurality of points on the first cylindrical crankpin 101 to obtain the respective pose of the first cylindrical crankpin 101 relative to the robot coordinate system CS0. Then, the controller may determine the pose of the rotating axis 100 of the crankshaft 10 relative to the robot coordinate system CS0 based on the respective pose of the first cylindrical crankpin 101.

It is to be understood that, in other embodiments, the controller may cause the positioner 40 to rotate to more than four angles. Similarly, the pose of the rotating axis 100 of the crankshaft 10 may be determined through the approaches as described above with reference to FIGS. 1-5. The specific procedure will not be described in detail herein.

It is to be understood that, although the calibration process is described above with respect to the first cylindrical crankpin 101, such calibration process may be implemented by using other crankpins of the crankshaft 10 as the measurement target, such as the second cylindrical crankpin 102, or the third cylindrical crankpin 103, or any other cylindrical crankpin.

As described above, the pose of the rotating axis 100 of the crankshaft 10 relative to the robot coordinate system CS0 has been obtained. However, since the crankshaft 10 can be mounted on the positioner 40 at any angle around the rotating axis 100, the pose of the crankshaft 10 is unknown when the positioner 40 rotates to a certain angle. That is, the position of the crankpins (such as the first, second, and third crankpins 101, 102, 103) of the crankshaft 10 is unknown when the positioner 40 rotates to a certain angle. Therefore, it is necessary to calibrate an angular offset of the crankshaft 10.

In some embodiments, the controller is further configured to create a first reference coordinate system based on the pose of the rotating axis 100 such that the rotating axis 100 coincides with one coordinate axis of the first reference coordinate system. FIG. 6 schematically illustrates the first reference coordinate system CS1 created based on the pose of the rotating axis 100 according to an embodiment of the present disclosure. As shown in FIG. 6, the first reference coordinate system CS1 includes three coordinate axes X1, Y1, and Z1 perpendicular to each other. The coordinate axis Z1 coincides with the rotating axis 100 of the crankshaft 10. The origin of the first reference coordinate system CS1 may be at any positon on the rotating axis 100. The coordinate axis X1 and the coordinate axis Y1 may be at any position in a plane perpendicular to the coordinate axis Z1. With these embodiments, the first reference coordinate system CS1 may be used as a basis of calibrating other pose parameters of the crankshaft 10, such as the angular offset of the crankshaft 10.

In some embodiments, in order to determine the angular offset of the crankshaft 10, the controller may first cause the positioner 40 to rotate to a predetermined angle, such as 0 degree, 10 degree, 90 degree, 120 degree, or any other angle in the range of 0-360 degree.

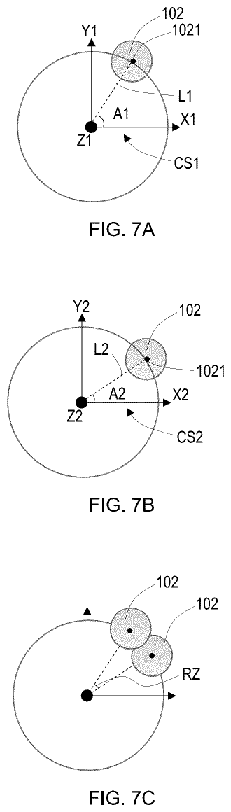

Then, the controller may determine a first angle of a central axis of a second cylindrical crankpin of the crankshaft in the first reference coordinate system when the positioner is at the predetermined angle. FIG. 7A schematically illustrates the first angle A1 of the central axis 1021 of the second cylindrical crankpin 102 in the first reference coordinate system CS1 according to a first embodiment of the present disclosure. As shown, the first angle A1 refers to an angle between the coordinate axis X1 and a connection line L1. The connection line L1 is between the origin of the first reference coordinate system CS1 and the central axis 1021 and perpendicular to the central axis 1021. The first angle A1 has a positive value in this embodiment.

Then, the controller may obtain a second angle of the central axis of the second cylindrical crankpin in a second reference coordinate system of a simulation station when the positioner is at the predetermined angle. FIG. 7B schematically illustrates the second angle A2 of the central axis 1021 of the second cylindrical crankpin 102 in the second reference coordinate system CS2 of the simulation station according to the first embodiment of the present disclosure. In the simulation station, the relative positon relationship between the crankshaft 10 and the positioner 40 is preset. The second reference coordinate system CS2 includes three coordinate axes X2, Y2, and Z2 perpendicular to each other. As shown in FIG. 7B, the second angle A2 refers to an angle between the coordinate axis X2 and a connection line L2. The connection line L2 is between the origin of the second reference coordinate system CS2 and the central axis 1021 and perpendicular to the central axis 1021. The second angle A2 has a positive value in this embodiment.

Then, the controller may determine the angular offset of the crankshaft 10 based on a difference between the first angle A1 and the second angle A2. FIG. 7C schematically illustrates the angular offset RZ of the crankshaft 10 according to the first embodiment of the present disclosure. As shown, the angular offset RZ equals to a difference between the first angle A1 and the second angle A2, i.e., RZ=A1−A2. Based on the angular offset RZ, the pose of the crankshaft 10 can be determined when the positioner 40 rotates to a certain angle.

In some embodiments, the controller is configured to determine the first angle A1 by the following operations. The controller may cause the probe 20 to touch a plurality of points on the second cylindrical crankpin 102 to obtain coordinates of the plurality of points on the second cylindrical crankpin 102 in the robot coordinate system CS0. Then, the controller may fit the coordinates of the plurality of points on the second cylindrical crankpin 102 to obtain the pose of the second cylindrical crankpin 102 relative to the robot coordinate system CS0. The specific process of the above operations may be implemented in the same manner as that described above with respect to the first cylindrical crankpin 101 during the calibration of the pose of the rotating axis 100, and will not be described in detail here. In the case that the pose of the second cylindrical crankpin 102 relative to the robot coordinate system CS0 has been determined, the respective pose of the central axis 1021 of the second cylindrical crankpin 102 is also known. Then, the controller may determine the first angle A1 based on the pose of the second cylindrical crankpin 102 and the first reference coordinate system CS1.

It is to be understood that, although the first angle A1 is an angle relative to the coordinate axis X1 and the second angle A2 is an angle relative to the coordinate axis X2 in the embodiments of FIGS. 7A-7C, the first angle A1 may represent an angle relative to the coordinate axis Y1 and the second angle A2 may represent an angle relative to the coordinate axis Y2 in other embodiments. The scope of the present disclosure is not intended to be limited in this respect.

It is to be understood that, although the calibration process of the angular offset RZ is described with respect to the second cylindrical crankpin 102, such calibration process may be implemented by using other crankpins of the crankshaft 10 as the measurement target, such as the first cylindrical crankpin 101, or the third cylindrical crankpin 103, or any other cylindrical crankpin.

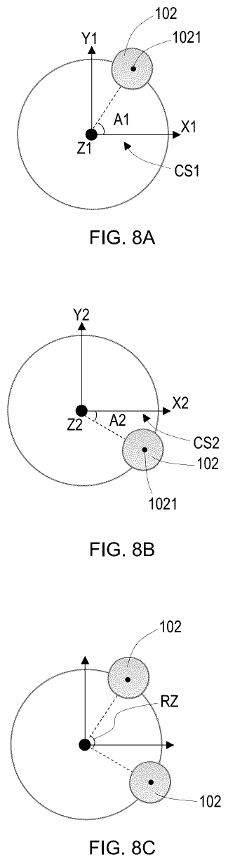

FIGS. 8A-8C schematically illustrate an example process of determining the angular offset RZ of the crankshaft 10 according to another embodiment of the present disclosure. The calibration process of the angular offset RZ as shown in FIGS. 8A-8C is similar to that as shown in FIGS. 7A-7C. The difference between them is that the first angle A1 has a positive value and the second angle A2 has a negative value. Similarly, the angular offset RZ equals to the difference between the first angle A1 and the second angle A2, i.e., RZ=A1−A2. Based on the angular offset RZ, the pose of the crankshaft 10 can be determined when the positioner 40 rotates to a certain angle.

It is to be understood that according to embodiments of the present disclosure, each of the first angle A1 and the second angle A2 may have a positive value, a negative value or a zero value which depends on the first reference coordinate system CS1 and the second reference coordinate system CS2. Regardless of the values of the first angle A1 and the second angle A2, the angular offset RZ may be determined based on the difference between the first angle A1 and the second angle A2.

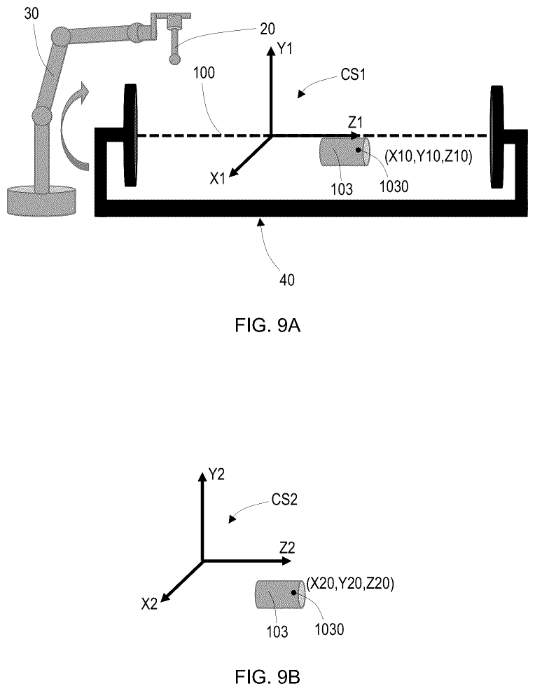

When the crankshaft 10 is mounted on the positioner 40, it is also necessary to determine a position offset of the crankshaft 10 along the rotating axis 100. FIGS. 9A-9B schematically illustrate an example process of determining the position offset of the crankshaft 10 along the rotating axis 100 according to an embodiment of the present disclosure. Only the third cylindrical crankpin 103 is shown in FIGS. 9A-9B so as to facilitate the understanding of the process of determining the position offset. As shown in FIG. 9A, the controller may cause the probe 20 to touch an oil hole 1030 on the third cylindrical crankpin 103 to obtain a first coordinate (X10, Y10, Z10) of the oil hole 1030 in the first reference coordinate system CS1. As shown in FIG. 9B, the controller may obtain a second coordinate (X20, Y20, Z20) of the oil hole 1030 in the second reference coordinate system CS2. Then, the controller may determine the position offset of the crankshaft 10 along the rotating axis 100 based on the first coordinate (X10, Y10, Z10) and the second coordinate of the oil hole (X20, Y20, Z20). For example, the position offset of the crankshaft 10 along the rotating axis 100 may equal to the difference between the coordinate Z10 and the coordinate Z20.

In some embodiments, instead of touching the oil hole 1030 on the third cylindrical crankpin 103, the probe 20 may touch an oil hole on the main journal 104 so as to determine the position offset of the crankshaft 10 along the rotating axis 100. In other embodiments, the probe 20 may touch other structural features on the crankshaft 10 so as to determine the position offset of the crankshaft 10 along the rotating axis 100. The scope of the present disclosure is not intended to be limited in this respect.

It is to be understood that the angular offset RZ of the crankshaft 10 and the position offset of the crankshaft 10 along the rotating axis 100 may be determined in other manners. For example, the controller may cause the probe 20 to touch a plurality of oil holes on the crankpins and the main journal 104 to obtain a first set of coordinates of the oil holes in the first reference coordinate system CS1. Then, the controller may obtain a second set of coordinates of the oil holes in the second reference coordinate system CS2. Based on the first set of coordinates and the second set of coordinates of the oil holes, the controller may determine the angular offset RZ of the crankshaft 10 and the position offset of the crankshaft 10 along the rotating axis 100.

After the pose of the rotating axis 100 of the crankshaft 10, the angular offset RZ of the crankshaft 10, and the position offset of the crankshaft 10 along the rotating axis 100 have been determined, the actual position of the crankshaft 10 is obtained.

According to embodiments of the present disclosure, the cylindrical crankpins are selected as the measurement target on the very complex and irregular crankshaft. Moreover, the crankshaft pose and central axis parameters can be calculated indirectly by measuring the movement difference of the target under multiple different attitudes.

According to embodiments of the present disclosure, analyzing and filtering the intermediate data and fitting the resulted data can provide a more accurate calibration result.

According to embodiments of the present disclosure, the calibration of the crankshaft can be carried out automatically, such that the measurement error of manual calibration is effectively avoided. In this way, the time consumed by the calibration can be saved, and the difficulty of calibration can be reduced. At the same time, the calibration process has a low cost and an extremely low error.

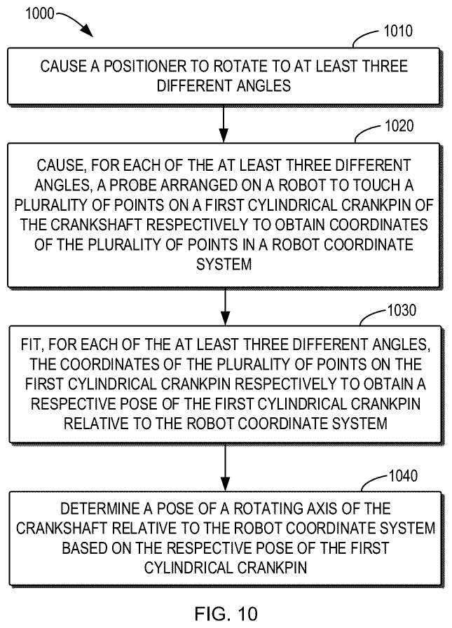

FIG. 10 is a flowchart of a method for calibrating a crankshaft to be processed according to an embodiment of the present disclosure. The method 1000 can be carried out by, for example the apparatus 900 for calibrating a crankshaft to be processed as described above with reference to in FIGS. 1-9B.

At block 1010, a positioner 40 is caused to rotate to at least three different angles, wherein the positioner 40 is configured to support the crankshaft 10 and drive the crankshaft 10 to rotate.

At block 1020, for each of the at least three different angles, a probe 20 arranged on a robot 30 is caused to touch a plurality of points on a first cylindrical crankpin 101 of the crankshaft 10 respectively to obtain coordinates of the plurality of points in a robot coordinate system CS0.

At block 1030, for each of the at least three different angles, the coordinates of the plurality of points on the first cylindrical crankpin 101 is fitted respectively to obtain a respective pose of the first cylindrical crankpin 101 relative to the robot coordinate system CS0.

At block 1040, a pose of a rotating axis 100 of the crankshaft 10 relative to the robot coordinate system CS0 is determined based on the respective pose of the first cylindrical crankpin 101. With these embodiments, the pose of the rotating axis 100 of the crankshaft 10 can be calibrated quickly and accurately.

In some embodiments, the method 100 further comprises: creating a first reference coordinate system CS1 based on the pose of the rotating axis 100 such that the rotating axis 100 coincides with one coordinate axis of the first reference coordinate system CS1. With these embodiments, the first reference coordinate system CS1 is created so as to further calibrate other pose parameters of the crankshaft 10.

In some embodiments, the method 100 further comprises: causing the positioner 40 to rotate to a predetermined angle; determining a first angle A1 of a central axis of a second cylindrical crankpin 102 of the crankshaft 10 in the first reference coordinate system CS1 when the positioner 40 is at the predetermined angle; obtaining a second angle A2 of the central axis of the second cylindrical crankpin 102 in a second reference coordinate system CS2 of a simulation station when the positioner 40 is at the predetermined angle; and determining an angular offset RZ of the crankshaft 10 based on a difference between the first angle A1 and the second angle A2. With these embodiments, the angular offset RZ of the crankshaft 10 can be determined quickly and accurately.

In some embodiments, determining the first angle A1 comprises: causing the probe 20 to touch a plurality of points on the second cylindrical crankpin 102 to obtain coordinates of the plurality of points on the second cylindrical crankpin 102 in the robot coordinate system CS0; fitting the coordinates of the plurality of points on the second cylindrical crankpin 102 to obtain a pose of the second cylindrical crankpin 102 relative to the robot coordinate system CS0; and determining the first angle A1 based on the pose of the second cylindrical crankpin 102 and the first reference coordinate system CS1. With these embodiments, the first angle A1 can be determined accurately.

In some embodiments, the first cylindrical crankpin 101 and the second cylindrical crankpin 102 are the same one crankpin or different crankpins of the crankshaft 10.

In some embodiments, the method 100 further comprises: causing the probe 20 to touch an oil hole 1030 on a third cylindrical crankpin 103 or a main journal 104 of the crankshaft 10 to obtain a first coordinate of the oil hole 1030 in the first reference coordinate system CS1; obtaining a second coordinate of the oil hole 1030 in a second reference coordinate system CS2 of a simulation station; and determining a position offset of the crankshaft 10 along the rotating axis 100 based on the first coordinate and the second coordinate of the oil hole 1030. With these embodiments, the position offset of the crankshaft 10 along the rotating axis 100 can be determined quickly and accurately.

In some embodiments, the first cylindrical crankpin 101 and the third cylindrical crankpin 103 are the same one crankpin or different crankpins of the crankshaft 10.

In some embodiments of the present disclosure, a computer readable medium is provided. The computer readable medium has instructions stored thereon, and the instructions, when executed on at least one processor, may cause at least one processor to perform the method for calibrating a crankshaft to be processed as described in the preceding paragraphs, and details will be omitted hereinafter.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. On the other hand, various features that are described in the context of a single embodiment may also be implemented in multiple embodiments separately or in any suitable sub-combination.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method for calibrating a crankshaft to be processed, the method comprising:
causing a positioner to rotate to at least three different angles, wherein the positioner is configured to support the crankshaft and drive the crankshaft to rotate;
causing, for each of the at least three different angles, a probe arranged on a robot to touch a plurality of points on a first cylindrical crankpin of the crankshaft respectively to obtain coordinates of the plurality of points in a robot coordinate system;
fitting, for each of the at least three different angles, the coordinates of the plurality of points on the first cylindrical crankpin respectively to obtain a respective pose of the first cylindrical crankpin relative to the robot coordinate system; and
determining a pose of a rotating axis of the crankshaft relative to the robot coordinate system based on the respective pose of the first cylindrical crankpin.

2. The method according to claim 1, further comprising:
creating a first reference coordinate system based on the pose of the rotating axis such that the rotating axis coincides with one coordinate axis of the first reference coordinate system.

3. The method according to claim 2, further comprising:
causing the positioner to rotate to a predetermined angle;
determining a first angle of a central axis of a second cylindrical crankpin of the crankshaft in the first reference coordinate system when the positioner is at the predetermined angle;
obtaining a second angle of the central axis of the second cylindrical crankpin in a second reference coordinate system of a simulation station when the positioner is at the predetermined angle; and
determining an angular offset of the crankshaft based on a difference between the first angle and the second angle.

4. The method according to claim 3, wherein determining the first angle comprises:
causing the probe to touch a plurality of points on the second cylindrical crankpin to obtain coordinates of the plurality of points on the second cylindrical crankpin in the robot coordinate system;
fitting the coordinates of the plurality of points on the second cylindrical crankpin to obtain a pose of the second cylindrical crankpin relative to the robot coordinate system; and
determining the first angle based on the pose of the second cylindrical crankpin and the first reference coordinate system.

5. The method according to claim 3, wherein the first cylindrical crankpin and the second cylindrical crankpin are the same one crankpin or different crankpins of the crankshaft.

6. The method according to claim 2, further comprising:
causing the probe to touch an oil hole on a third cylindrical crankpin or a main journal of the crankshaft to obtain a first coordinate of the oil hole in the first reference coordinate system;
obtaining a second coordinate of the oil hole in a second reference coordinate system of a simulation station; and
determining a position offset of the crankshaft along the rotating axis based on the first coordinate and the second coordinate of the oil hole.

7. The method according to claim 6, wherein the first cylindrical crankpin and the third cylindrical crankpin are the same one crankpin or different crankpins of the crankshaft.

8. An apparatus for calibrating a crankshaft to be processed, the apparatus comprising:
a probe arranged on a robot;
a positioner configured to support the crankshaft and drive the crankshaft to rotate; and
a controller configured to:
cause the positioner to rotate to at least three different angles;
cause, for each of the at least three different angles, the probe to touch a plurality of points on a first cylindrical crankpin of the crankshaft respectively to obtain coordinates of the plurality of points in a robot coordinate system;
fit, for each of the at least three different angles, the coordinates of the plurality of points on the first cylindrical crankpin respectively to obtain a respective pose of the first cylindrical crankpin relative to the robot coordinate system; and
determine a pose of a rotating axis of the crankshaft relative to the robot coordinate system based on the respective pose of the first cylindrical crankpin.

9. The apparatus according to claim 8, wherein the controller is further configured to:
create a first reference coordinate system based on the pose of the rotating axis such that the rotating axis coincides with one coordinate axis of the first reference coordinate system.

10. The apparatus according to claim 9, wherein the controller is further configured to:
cause the positioner to rotate to a predetermined angle;
determine a first angle of a central axis of a second cylindrical crankpin of the crankshaft in the first reference coordinate system when the positioner is at the predetermined angle;
obtain a second angle of the central axis of the second cylindrical crankpin in a second reference coordinate system of a simulation station when the positioner is at the predetermined angle; and
determine an angular offset of the crankshaft based on a difference between the first angle and the second angle.

11. The apparatus according to claim 10, wherein the controller is configured to determine the first angle by:
causing the probe to touch a plurality of points on the second cylindrical crankpin to obtain coordinates of the plurality of points on the second cylindrical crankpin in the robot coordinate system;
fitting the coordinates of the plurality of points on the second cylindrical crankpin to obtain a pose of the second cylindrical crankpin relative to the robot coordinate system; and
determining the first angle based on the pose of the second cylindrical crankpin and the first reference coordinate system.

12. The apparatus according to claim 10, wherein the first cylindrical crankpin and the second cylindrical crankpin are the same one crankpin or different crankpins of the crankshaft.

13. The apparatus according to claim 9, wherein the controller is further configured to:
cause the probe to touch an oil hole on a third cylindrical crankpin or a main journal of the crankshaft to obtain a first coordinate of the oil hole in the first reference coordinate system;
obtain a second coordinate of the oil hole in a second reference coordinate system of a simulation station; and
determine a position offset of the crankshaft along the rotating axis based on the first coordinate and the second coordinate of the oil hole.

14. The apparatus according to claim 13, wherein the first cylindrical crankpin and the third cylindrical crankpin are the same one crankpin or different crankpins of the crankshaft.

15. A computer readable medium having instructions stored thereon, the instructions, when executed on at least one processor, cause the at least one processor to perform the method according to claim 1.
